(19) United States
(12) Patent Application Publication
(10) Pub. No.: US 2008/0183635 A1
(43) Pub. Date: Jul. 31, 2008

(54) Financing instrument evaluation based on equivalent time-scale based calculations

(76) Inventor: Leslie Hayman, Toronto (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, omitted

(21) Appl. No.: 11/657,579

(22) Filed: Jan. 25, 2007

(51) Int. Cl. G06Q 40/00

(52) U.S. Cl. 705/36 R

(57) ABSTRACT

A system and method for evaluating financing instruments selected from a group of financing instruments available on a market. The market provides a plurality of dynamic exchange-based valuation events for each of the selected financing instruments. The system comprises an equivalence module configured for determining a fundamental value for each of the selected financing instruments, the fundamental value including at least one quantity independent of the dynamic exchange-based valuation events. A measures module is configured for calculating a plurality of measures based on information related to each of the selected assets. A factor module is configured for assigning at least one evaluation factor to each of the selected financing instruments when a threshold criterion is satisfied according to the comparison of at least one of the plurality of measures with at least one valuation including the fundamental value. A report module assembles the result of the evaluation factor assignment in a report for sending to a requestor of the report.

### FIELD OF THE INVENTION

This invention relates to evaluation of investments and more specifically to the use of time-scale benchmarking.

### BACKGROUND OF THE INVENTION

Proper investment and investment strategies are important factors for the determining the health and well being of local and world economies. Desirable performance of investments is important in general in terms of retirement quality for the investing population, as it is important specifically for raising capital for use in financing of individual company growth and exploration. Accordingly, the methodology used for guiding investment in selected companies and economic sectors can make the difference between success and failure for investment performance.

Unfortunately, current investment methodologies rely heavily on the use of technical price/trade oriented measures to drive trade activity (e.g. sell, hold, buy) for selected financing instruments (e.g. stocks, bonds, etc.). These technical price/trade oriented measures do not necessarily reflect the fundamental measures of the companies underlying the selected financing instruments, thus resulting in potentially undesirable inherent risk in those financing instruments. One example is the tech bubble bust of 2000, in which company evaluations were completely stock market driven and not effectively related to actual fundamental company performance.

A further disadvantage with current investment methodologies is the benchmarking of financing instruments with respect to one another is done using inconsistent or otherwise shifting benchmarks that are typically only related to external company factors, such as individual market price and trade volumes compared only to average market price/volumes.

### SUMMARY OF THE INVENTION

It is an object of the present invention to provide an financing instrument evaluation system to obviate or mitigate at least some of the above-presented disadvantages.

Provided is a system for evaluating financing instruments selected from a group of financing instruments available on a market, the market for providing a plurality of dynamic exchange-based valuation events for each of the selected financing instruments, the system comprising: an equivalence module configured for determining a fundamental value for each of the selected financing instruments, the fundamental value including at least one quantity independent of the dynamic exchange-based valuation events; a measures module configured for calculating a plurality of measures based on information related to each of the selected assets; a factor module configured for assigning at least one evaluation factor to each of the selected financing instruments when a threshold criterion is satisfied according to the comparison of at least one of the plurality of measures with at least one valuation including the fundamental value; and a report module for assembling the result of the evaluation factor assignment in a report for sending to a requester of the report.

Also provided is a method for evaluating financing instruments selected from a group of financing instruments available on a market, the market for providing a plurality of dynamic exchange-based valuation events for each of the selected financing instruments, the method comprising the acts of: determining a fundamental value for each of the selected financing instruments, the fundamental value including at least one quantity independent of the dynamic exchange-based valuation events; calculating a plurality of measures based on information related to each of the selected financing instruments; assigning at least one evaluation factor to each of the selected financing instruments when a threshold criterion is satisfied according to the comparison of at least one of the plurality of measures with at least one valuation including the fundamental value; and assembling the result of the evaluation factor assignment in a report for sending to a requestor of the report.

### BRIEF DESCRIPTION OF THE DRAWINGS

Exemplary embodiments of the invention will now be described in conjunction with the following drawings, by way of example only, in which:

FIG. 1 is a block diagram of components of an investment management environment;

FIG. 2 shows different example financing instrument sectors for the selected financing instruments of the system of FIG. 1;

FIG. 3 is a block diagram of an financing instrument evaluation system of the system of FIG. 1;

FIG. 4 shows an example embodiment of the financing instrument evaluation system of FIG. 3;

FIG. 5 is a block diagram of the factor module of the system of FIG. 4;

FIG. 6 shows examples of the evaluation factors generated by the factor module of FIG. 5;

FIG. 7 is a flowchart of an example operation of the financing instrument evaluation system of FIG. 4;

FIG. 8 is a flowchart of an example operation of the factor module of FIG. 5;

FIG. 9 is a block diagram of an example computing device for hosting the components of the investment management environment of FIG. 1; and

FIG. 10 is a block diagram of an example factor values generated by the factor module of FIG. 5.

### DETAILED DESCRIPTION OF THE PREFERRED EMBODIMENT(S)

### Investment Management Environment 10

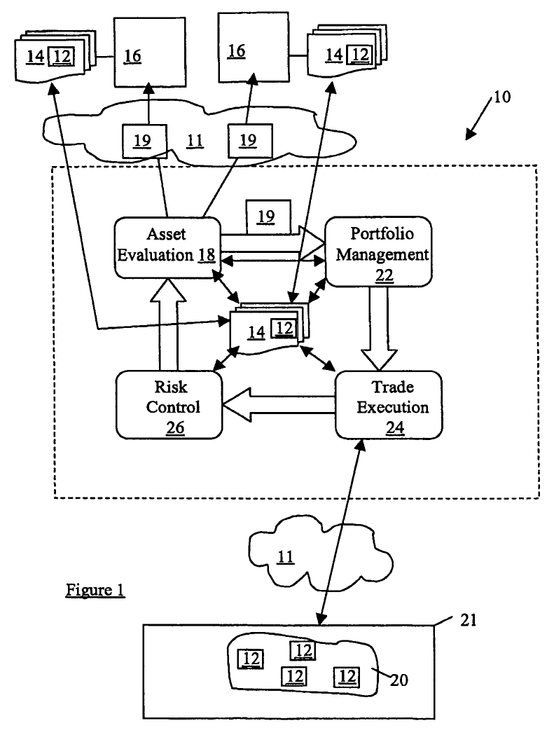

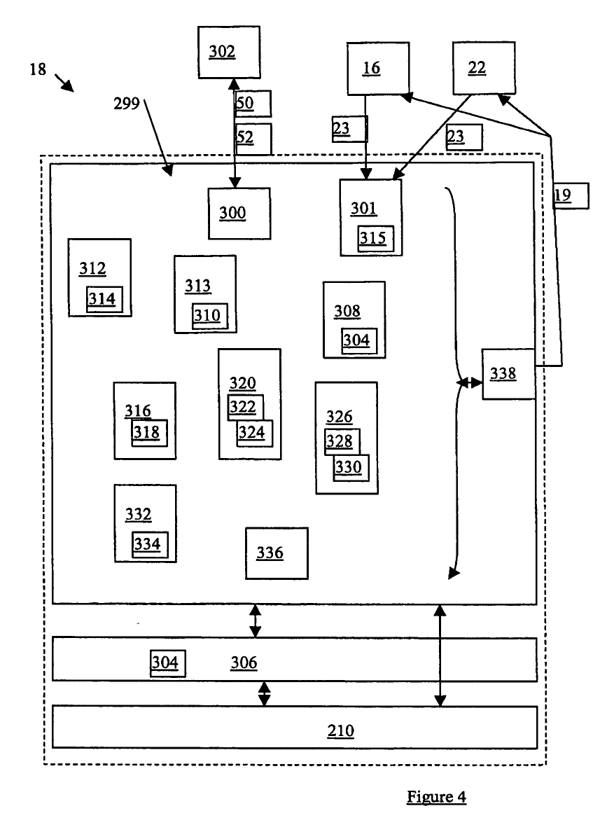

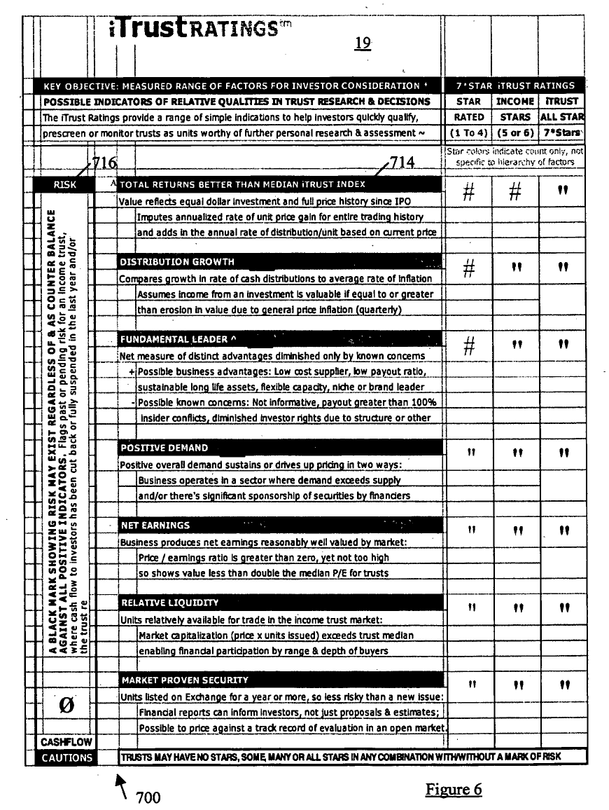

Referring to FIG. 1, shown is an investment management environment 10 for facilitating the purchase and sale of financial instruments/financing instruments 12 of investment portfolios 14 of one or more investing entities 16 (e.g. individual, managed fund, etc.). The environment 10 includes an financing instrument evaluation system 18 configured for reporting on financing instruments 12 selected from an financing instrument group 20 made available through one or more public/private markets 21 (e.g. stock exchange), based on the predefined financing instrument evaluation framework/system 18 (see FIG. 4), further described below. The evaluated financing instruments 12 are assembled into an financing instrument evaluation report 19 that is made available to the entities 16 and/or a portfolio management system 22 coupled to the financing instrument selection system 18. The report 19 includes a plurality of evaluation factors 700 (see FIG. 6) determined for each of the financing instruments 12. The portfolio management system 22 is configured for making trade decisions (i.e. purchase, hold, sell) for each of the financing instruments 12 in the report 19, based on determined portfolio 14 investing criteria. These investing criteria can include parameters such as but not limited to, for example: acceptable risk; farther supplemental information on the evaluated financing instruments 12; real-time pricing of the evaluated financing instruments 12 in the market 21; risk metric modelling; and economic and sector outlook information related to the evaluated financing instruments 12. It is recognised that the components 18,22,24,26 of the environment 10, as well as the investing entities 16, can communicate with one another and the market(s) 21 via one or more networks 11, such as but not limited to intranets and extranets (e.g. the Internet) as desired.

Referring again to FIG. 1, the environment 10 also has an execution system 24 coupled to the portfolio management system 22. The execution system 24 is responsible for facilitating optimized timing of trade decisions in the market(s) 21, for implementing trades in the market(s) 21 for those evaluated financing instruments 12 selected from the report 19 based on the investing criteria. The financing instrument 12 contents of the investment portfolios 14 are subsequently updated based on the outcome of the market trades (e.g. number of stocks purchased/sold at what price). The environment 10 can also have a risk control system 26 for facilitating audit and review of the market trades. It is recognised that the components 18, 22, 24, 26 of the environment 10 can operate in a cyclical manner in order to facilitate ongoing monitoring of the performance (e.g. total return and yield) of the portfolios 14.

### Financial Instruments 12

The markets 21 can be defined by their characteristic nature of providing periodic/dynamic exchange-based valuation events. An example of the periodic/dynamic exchange-based valuation events are fluctuating or otherwise dynamically changing daily/real-time numbers for the volume and/or pricing, such as prices/volumes for buy/sell/bought/sold trading activities for financing instruments 10 that are in the market environment handled as derivatives. Other periods can be weeks, months, quarterly, annual, etc.

Any financial instrument 12 traded in a public exchange is, in fact, derivative of an underlying asset/liability of the issuing commercial entity (e.g. company).

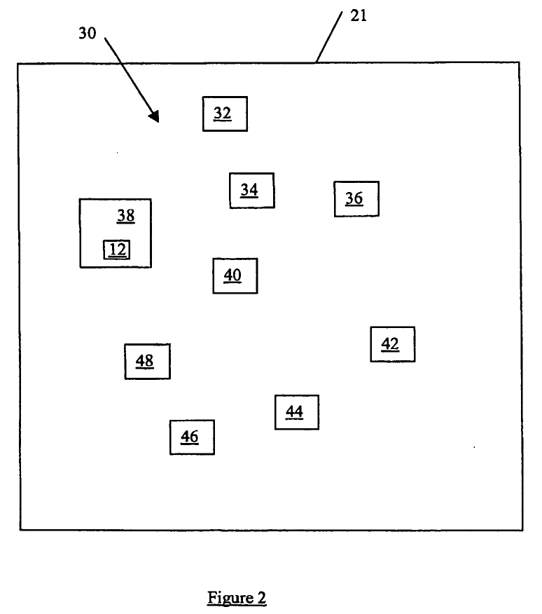

Referring to FIG. 2, the financing instruments 12 can be from one or more sectors 30, such as but not limited to: trusts 32; oil and gas 34; energy related 36; food related 38; REIT 40; business 42; finds 44 (e.g. diversified); selected stock exchanges or portions of stock exchanges 46 (e.g. S&P/TSX 60 equities); and selected financing instrument types 48 (e.g. Canadian bonds). The type of financing instruments 12 can include financing instruments such as but not limited to, for example securities or security classes such as: common shares; preferred shares; debentures; convertible debentures; partnerships; closed trusts; open trusts; and exchange traded fund of finds. It is recognised that the markets 21 are configured to provide a pricing mechanism for the financing instruments 12 involving a series of pricing events (e.g. periodic/dynamic exchange-based valuation events) for each of the financing instruments 12 that are available for selected periods of time, i.e. prices of individual financing instruments 12 on the market 21 are published or otherwise made available repeatedly (e.g. price of a stock with changes thereto posted in real-time with the ability to obtain past prices).

### Input Information 50,52 for Benchmarking Purposes

### Benchmarking

In view of the above, the term benchmarking or indexing (either internal or external) refers to the process of determining valuations through calculations involving different quantities related to the financing instrument 12 (and underlying company) and then comparing those valuations to a defined standard valuation. The valuation and standard valuation can be related to fundamental values 310 of the selected financing instrument 12, external values related to the valuation events given by example above, or a combination thereof.

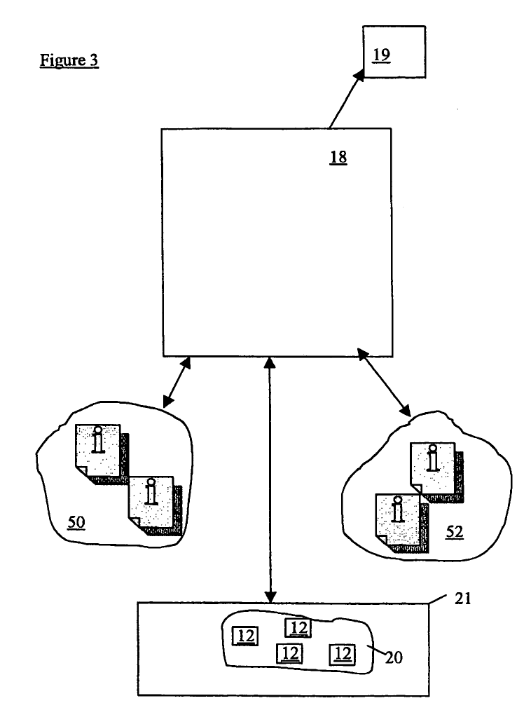

Referring to FIG. 3, the financing instrument evaluation system 18 is configured to evaluate selected financing instruments 12 based on information selected from external information 50 and/or internal information 52. The information 50,52 is used as input data for the purposes of internal and external benchmarking of economic performance of the underlying entities representing the financing instruments 12 (e.g. companies producing goods and/or services, named fund management companies, etc.), hereafter referred to as company for the sake of simplicity, further described below. The use of internal and external benchmarking provides an advantage of tracking market 21 and constituent qualities of the financing instruments 12 through consideration of dynamics and relevant changes beyond the externally oriented market 21 price and/or trade measures (i.e. technical measures). For example, the use of internal combined with external benchmarking of publicly/privately traded (involving reliable pricing event information) financing instruments 12 can be used to determine underlying business qualities significant in the selection of convertible debentures and other debt instruments from the issuer (e.g. company). This determination is represented in the content of the evaluation report 19 (see FIG. 1), as further described below. Examples of the information 50,52 categories can include business specific data such as but not limited to: fundamental business data; ratios data; corporate actions and financing data; market 21 pricing; and economic measures.

### External Information 50

The external information 50 is collected by a data collection module 300 (see FIG. 4). The external information 50 can represent those information quantities/qualities for the financing instruments 12 that do not explicitly involve the underlying fundamentals of the entities represented by the financing instruments 12. It is recognised that trade decisions for some prior art portfolio management systems (e.g. day trading systems) predominantly rely upon such external information 50 quantities/qualities, such as real-time price and/or volumes of the financing instruments 12 in the market(s) 21.

The external information 50 can include information such as but not limited to: company name; financing instrument 12 symbol (e.g. issue/trading symbol); financing instrument 12 price and time/date (e.g. closing price); financing instrument 12 volume and time/date (e.g. closing volume); average price of financing instruments 12 of a particular class/category/sector 30 for a unit for initial public offering, usual minimum trade quantity for financing instruments 12 in a particular class/category/sector 30; economic data related to price in the context of other prices;

### Internal Information 52

The internal information 52 is collected by the data collection module 300 for determining data related to information applicable to determining distinctions about the quality of net financing instruments and operations of the companies represented by the financing instruments 12. It is recognised that this information 52 comes from the company itself and is not influenced or otherwise manipulated by market 21 price considerations (e.g. externally driven irrational performance indicators not necessarily tied to actual company performance).

The internal information 52 can include information such as but not limited to: income and cash flow statements; balance sheets; unit price and date of first issue of the financing instrument 12 (e.g. IPO information); date and price of Initial Public Offering (IPO); instances of public reporting regularity and irregularity; Nominal Dividend Payments by quarter; Nominal Cash Flow from Continuing Operations; Market Capitalization; Tangible Book Value; Nominal Book Value; invested capital over time; Debt; Equity; Indication of Convertible Debenture issue; Web site address; if security issued by a Fund Manager then indication of index or passive management approach; if security issued by an oil or gas producer then Reserve Life Index (RLI) measure; four years trailing revenues; four years trailing dividends; Prior Revenues, preferably for 3 years or more; Current Capital Expenditure; Prior Capital Expenditures, preferably for 3 years or more; Quarterly Revenues; Quarterly Operating Costs; and Reserve Life Index (RLI) for oil and gas producers. It is recognised that the unit measures indicated above (e.g. four year, three year, etc.) can be other unit quantities than stated.

The financing instrument evaluation system 18 uses the information 50, 52 to perform the combination of internally and externally based benchmarking calculations to result in the generation (or decided lack of generation) of a variety of factors 700 (see FIG. 6). In general, benchmarking of the financing instruments 12 based on a fundamental value 310 (see FIG. 4) provides a rational, quantifiable basis for the comparison of two or more potentially similar financing instruments 12. Calculation of the factors 700 based on the fundamental value 310 facilitates the investing entity 16 and/or portfolio management system 22 (see FIG. 1) to objectively compare multiple financing instruments 12 on an equivalent basis. The benchmarking can be used to evaluate various aspects of the financing instruments 12 (based on the factors 700) in relation to best or most promising financing instruments 12, for example within their own sector 30 or between sectors 30, as desired. This then allows the investing entity 16 and/or portfolio management system 22 to develop plans on how to decide on appropriate trade decisions, usually with the aim of increasing some aspect of performance of the portfolio 14. Benchmarking may be a one-off event, but is often treated as a continuous process in which the investing entity 16 and/or portfolio management system 22 continually seek to improve their investment practices. Calculation of the fundamental value 310 is done by an equivalent weight index module 313 of the system 18, as further described below.

In view of the above, it is recognised that some of the above-described information can be included in both the external 50 and internal 52 information classes, based on the type of internal/external benchmarking calculation performed, as further described below. For example, a benchmarking calculation involving both internal 52 and external 50 information could be classified as an internal benchmark (i.e. involving at least some internal information 52 as classified/defined by the financing instrument evaluation system 18) while a benchmarking calculation involving only external 50 information could be classified as an external benchmark (i.e. involving only external information 50 as classified/defined by the financing instrument evaluation system 18). It is recognised that internal benchmarking (also referred to as independent benchmarking) can also refer to those calculations that include at least one quantity that is outside of the exchange-based valuation events

### Financing Instrument Evaluation System 18

Referring to FIG. 4, the financing instrument evaluation system 18 is configured for evaluating selected financing instruments/investments 12 with the objective of facilitating, through subsequent analysis of the report 19, trade decisions to obtain the rights of ownership (including risks and returns) for financing instruments 12 based on fundamental measurements/calculations that are distinct from quantitative, qualitative or technical techniques for assessment based on the external benchmarking of market 21 pricing and volumes alone.

Advantages of the system 18 are inherent in using the evaluation report 19 to help guide investment decisions for the selected financing instruments 12. These advantages for potential positive investment performance can be such as but not limited to: consistently identify total return, high yield financing instruments with of reduced risk; total annualized returns better than trust market median; growth in distribution rates better than inflation; fundamental leader and net positive on quantitative return and underlying operational measures; positive demand including either stable or growing top-line revenues over three years and/or units priced to demonstrate positive demand so that yield does not exceed median; positive earnings but price does not exceed risk-adjusted return rates (e.g. relative to 3-mth Canadian T-Bills: P/E of 1< >24); relative liquidity with better than median issue size; and market proven with at least minimum (e.g. 3) quarters of public financial reports.

Referring again to FIG. 4, the system 18 has a plurality of modules 299 including a scope module 301 for selecting the desired mix of chosen financing instruments 12 and/or sectors 30 (see FIG. 2), as well as for determining an INDEX WEIGHT value 315 for use in calculation of the fundamental value 310 for each of the selected financing instruments 12. The entity 16 (and/or portfolio management system 22) desiring the evaluation report 19 (e.g. either initially or on a repeated basis) provides investment scope information 23 to the scope module 301, which is configured to then identify available information sources 302 (e.g. predefined in the storage 210) for obtaining the required investment information 50,52. The scope module 301 can store the information 23 in the storage 210 for subsequent access by a data collection module 300, and/or otherwise inform the data collection module 300 directly, as desired. The data collection module 300 is configured to facilitate the collection of the information 50,52 from the sources 302 initially and then on a cyclic basis according to defined collection frequencies 304, as directed by a workflow engine 306. The workflow engine 306 is configured to coordinate operation of the financing instrument evaluation system 18, manually through interaction with an administrator, automatically as programmed by the administrator, or a combination thereof.

Referring again to FIG. 4, the system 18 further has a frequency module 308 configured to determine the cyclic frequency 304 of the financing instrument 12 calculations to be included in the evaluation report 19. The frequency module 308 can also be configured to determine the fundamental value 310 for use in calculation of the evaluation factors 700 (see FIG. 6), further described below. Calculation of the fundamental value 310 is done by an equivalent weight index module 313, which involves the use of the INDEX WEIGHT value 315 in order to provide for comparison of the selected financing instruments 12 on a per unit basis, as further described below.

The system 18 can also have a risk module 312 configured to calculate a risk factor 314 for each of the financing instruments 12 of which the respective company fails to conduct public reporting with integrity and/or consistency. The calculation of the risk factor 314 is facilitated by internal information 52 collected by the data module 300 and can be included in the evaluation report 19 with the factors 700, as desired.

Referring again to FIG. 4, the system 18 also has an external/macro indicator module 316, which is configured to calculate macro economic and market measures 318 based on external information 52. A further module is a relative value module 320 for calculating relative values 322 for each of the selected financing instruments 12 based on predominantly internal information 52 and potentially some external information 50, as desired. A consideration module 326 is used by the system 18 to determine if there are any quantifiable concerns 328 or differentiating advantages 330 for the companies of the selected financing instruments 12. A price related benchmarking module 332 is used to calculate price benchmarks 334 that can be a combination of internal 52 and external 50 information.

Referring again to FIG. 4, a factor module 336 is used to calculate the evaluation factors 700 (see FIG. 6) used to facilitate the trade decisions for the selected financing instruments 12. It is recognised that these evaluation factors 700 represent a combination of at least some of the internal and external benchmarking measures 310, 314, 315, 318, 322, 324, 328, 330, 334, as described above, and are intended to be included specifically in the evaluation report 19 (where appropriate) each of the selected financing instruments 12. Further, the system 18 also has a report module 338 for assembling the calculated measures 310,314,318,322,324,328,330,334 and factors 700 for inclusion, where appropriate, in the evaluation report 19. It is recognised that any of the modules 299 associated with the calculation of the measures 310-334 can also be referred to as a measures module.

### Scope Module 301

The scope of investment is determined through the scope module 301 for the desired mix of chosen financing instruments 12 and/or sectors 30 (see FIG. 2). The entity 16 (and/or portfolio management system 22) desiring the evaluation report 19 (e.g. either initially or on a repeated basis) provides the investment scope information 23 to the scope module 30, which is configured to then identify the available information sources 302 for obtaining the required information 50,52. In the event that information 50,52 is currently unavailable (e.g. no known source 302) for financing instruments 12 embodied by scope information 23, then the scope module 21 may communicate this to the entity 16 and/or portfolio management system 22 which may result in a change to the investment scope information 23.

For example, the investment scope information 23 can include in the choice of financing instruments 12 and/or sectors 30: the market(s) 21 involved; the type of financing instruments 12 desired (e.g. all types, shares, debentures, partnerships, trusts, funds, etc.); particular financing instruments 12, a range of financing instruments within a chosen class/category, and/or sectors 30 (e.g. selected companies, all Canadian stocks, all blue chip companies, etc.); identification of company-issue in a number of dimensions such as fundamental descriptors (e.g. company/SEDAR name), direct contact descriptor (e.g. company Web/physical address), and securities/market descriptor (e.g. trading symbol); and standard trade size for the securities class (e.g. an index weight such as the average price for a unit for initial public offering times the usual minimum trade quantity).

It should be recognised that the index weight calculation results in an INDEX WEIGHT value 315 for the selected asset class. An example of this is for income trusts, where the index weight would be equal to 100 units times $10 issue price for the value 315 of $1000. Accordingly, division of the INDEX WEIGHT value 315 by an financing instrument 12 price would give the resultant number of financing instrument units.

### Data Collection Module 300

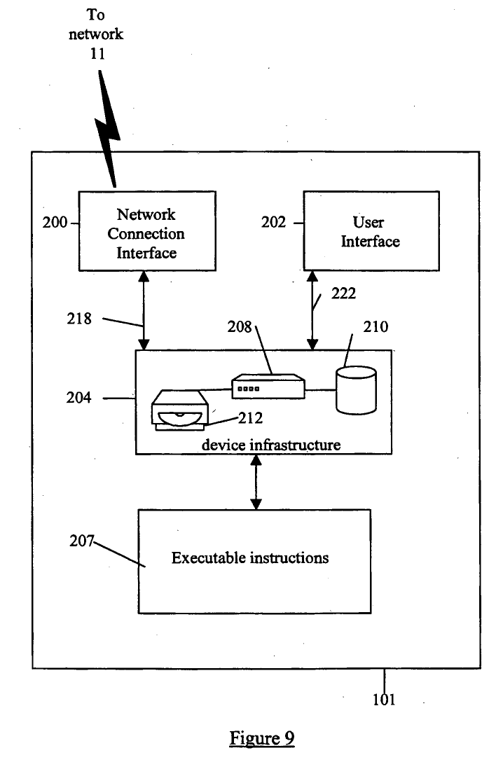

Referring again to FIG. 4, the data collection module 300 is configured to facilitate the collection of the information 50,52 from the sources 302 according to the defined collection frequencies 304, as specified by the workflow engine 306. The module 300 is coupled to the storage 210 (see FIG. 9) for storing of the information 50,52 data for use by the financing instrument management system 18.

The module 300 can be used to identify the sources 302 based on credibility and reliability factors for the desired information 50,52. Examples of the data sources 302 include, for example, sources such as but not limited to selected exchanges (e.g. TSX, NYSE); financial services for financial reports such as income and cash flow statements (e.g. Bloomberg, Thompson); and generic third party information sources (e.g. telephone book, company directory, Web searching).

### Frequency Module 308

again to FIG. 4, the frequency module 308 is used to determine the frequency 304 for the financing instrument 12 calculations to be included in the evaluation report 19, based on the determined investment scope by the module 301. The frequency module 308 calculates the frequency 304 based in part, for example, on a calculated equivalent-weight and time-scale index, preferably for those financing instruments 12 that have been a minimum calendar time history of reporting (e.g. one year, six months, etc.). It is recognised that the minimum calendar time history of reporting can be measured from the date of a fundamental value 310 of each of the companies, further described below.

The frequency module 308 also determines the generic timing of the financing instrument 12 price updates as well as the timing for collection of the internal/external information 52,50 to result in generation/update of the evaluation report 19, i.e. the evaluation frequency 304. Example factors to consider in calculating the frequency 304 can include factors such as but not limited to: intended frequency of cash distribution for the financing instruments 12 (e.g. monthly); planned size of cash distribution of the financing instruments 12 (e.g. monthly); information availability frequency of the financing instruments 12 (e.g. financial reporting cycle of the companies); and frequency class of the financing instruments 12 (e.g. in the case dissimilar reporting frequencies for companies).

Further, it is recognised that the module 308 could be configured to characterize companies-issues in terms of the smallest time cycle or frequency for reporting and providing relevant and consistent information about the company, where information is defined as security issuer (company) reporting to or payment of cash or other exchangeable financing instruments (such as additional shares) to security owners, for example. Further, if more than one reporting frequency is used by companies, then sub-classes of securities can be established based on frequency and an indicator can be created to characterize a specific security in terms of its sub-class (e.g. in terms of semi-annual, quarterly and monthly reporting or in the case where monthly basis by some companies while other companies pay a dividend quarterly, then securities within the class can include a choice of frequency—either a quarterly or monthly designation).

Further, it is recognised that it may not be necessary to set the frequency 304 so as to obtain live information updates of the financing instruments 12, as the only element of the investment information 50,52 changing on a nearly daily basis is the price of the financing instrument 12. It is considered that markets 21 and their inherently external information 50 are not necessarily efficient reflections of underlying value of the financing instruments 12, and short-term pricing is not the same as long term fundamental valuation.

### Risk Module 312

Referring again to FIG. 4, the risk module 312 calculates a risk factor 314 for each of the financing instruments 12 of which the respective company fails to conduct public reporting with integrity and/or consistency. For example, if and when such an instance is observed, the failure is added to a categorical register of such events, such that if a previous event has never occurred the register has a zero value. Quantitative counts for the risk factor 314 can suffice, but qualitative descriptions or related notes and references may also be useful. It is recognised that the collection module 300 can be used to observe nominal instances of company public reporting on an on-going and historic basis to identify and register by way of count, any and all instances of communicative and/or human behavioural lack of integrity or consistency. As well, such risk information can be received by the financing instrument evaluation system 18 via third party alerts (not shown), as desired.

Examples of the deemed risk communications/behaviour are situations such as but not limited to: instances of questionable behaviour related to Manager Accountability, Conflict of Interest, Confusing or Missing Information in regard to corporate events, including the following registers; stated but unmitigated conflicts of interest; manager/director proposes and ensures that bonus pay is received when business results are relatively negative; specific findings or settled results of formal inquiry into illegal behaviour related to management; and no response within set period of time (e.g. two weeks) by investor relations personnel/managers to investor-related questions repeated in more than one medium.

It is recognised that such negative indications (e.g. risk factors 314 greater than zero) should be maintained on file because their public appearance can be managed to ensure that they appear only briefly. Lack of integrity or consistency can indicate real risk in terns of lack of intelligent capability or rule-breaking intent given rules-based and self-regulatory financial markets. Tracking or recording news of a negative nature provides investors with valuable insights not commonly found in the market, i.e. it provides the security owner with competitive advantage in the market.

### Equivalent Weight Index Module 313

Calculation of the fundamental value 310 is done by an equivalent weight index module 313, which involves the use of the INDEX WEIGHT value 315 to enable comparison of the selected financing instruments 12 on an equivalent per unit basis.

The construction of the equivalent-weight and time-scale index for the financing instrument evaluation system 18 is unlike the more common and convenient market-weight, market-scale index, and other time-scale indices that disengage indicators from the original and fundamental conditions of the company-issue by shifting the relative period for indexation based on external information 52 only, see FIG. 2. The equivalent-weight and time-scale index used by the financing instrument evaluation system 18 is based on the integrity of perspective being protected and remaining in tact by measuring change in price over time relative only to the fundamental value 310 of the company (e.g. related to the original value of the issue—IPO price) being considered for investment, as further described below. Use of the particular time scale of the financing instrument evaluation system 18 facilitates information derived from it to remain essential or fundamental in relation to the company-issue being considered. Accordingly, the time-based nature of the fundamental value 310 provides for an equivalent basis for each company from which to compare changes in distribution rates, considered one measure indicative of the strength/worthiness for investment in any particular financing instrument 12. It is this capability to observe consistent and comparable changes in key company economic and operating performance measures that is considered suitable input for calculation of rating factors/stars 700 (see FIG. 6), further described below.

The fundamental value 310 of the company under consideration is recognized as inherently internal information 52 to that company and is not subject to significant external market 21 pressures in terms of dynamic influences once the date/price/amount of the fundamental value 310 has been set. One example of the fundamental value 310 is related to the date and price of the IPO for a respective company. Other fundamental values 310 can include example values related to such as but not limited to: the price on close of the first date of trade on a respective market 21 after the earliest IPO or index date (e.g. original public price); average of sellers and the original public price; issue quantity; or a combination thereof

It is recognised that time-based indexes that benchmark company returns relative to equivalent investor considerations (e.g. fundamental value 310) and that retain dynamic historical values over time can provide for investors to understand actual company returns in a relevant manner and to understand alternative investment through comparison of one company to another when viewed in such a similar way. Further, it is recognised that the fundamental value 310 can be considered a useful measure for indexation that is essentially defined by the issuer of an financing instrument 12 being assessed, i.e. in the context of the reporting issuer being assessed. The usage of fundamental value 310 can help to facilitate measures that are truly associated with the issuer or sellers' company being evaluated and not arbitrary or mistaken measures more closely associated with inherently external information 52, e.g. market 21 buyers' pricing, security buyers' unrelated timing, and competing demands for information.

For the sake of simplicity, the main fundamental value 310 is hereafter referred to as the Fundamental Number of Units for any particular selected financing instrument 12, for exemplary purposes only. In essence, the IPO set price for each of the selected financing instruments 12 is averaged with the first day closing price to establish an Initial Public Financing instrument Value in the calculation of the equivalent holding (e.g. a holding of $1000 for income trusts as noted by example above). The INDEX WEIGHT value 315 (e.g. $1000) for the class of selected financing instruments 12 is divided by the Initial Public Financing instrument Value (averaged IPO price) of each selected financing instrument 12 to give a Fundamental Number of Units for each of the financing instruments 12 (e.g. the fundamental value 310). At any given time in the calculation of measures 322,324,328,330,334 and the factors 700, the Fundamental Number of Units is multiplied by the current market 21 price to give the Nominal Current Value of the financing instrument 12, which is used in substitution of the current market 21 price of the financing instrument 12 in the calculation of the measures 322,324,328,330,334 and the factors 700. Further, the period of issue for each financing instrument 12 is used to calculate the annualized difference between the Nominal Current Value and the IPO value.

It should be noted that the Fundamental Number of Units (e.g. fundamental value 310) is a time-based internal benchmark because it is specific to and unique for each of the selected financing instruments 12. Use of this fundamental value 310 facilitates the calculation of internal benchmark measures for different companies that are independent of purely external comparison of market 21 price and volume measures related to the financing instruments 12 issued by those companies.

As noted above, one example of the fundamental value 310 is related to the date and price of the IPO for a respective company. Other fundamental values 310 can include example values related to such as but not limited to: the price on close of the first date of trade on a respective market 21 after the earliest IPO or index date (e.g. original public price); average of sellers and the original public price; issue quantity; or a combination thereof.

Further, the fundamental value 310 can be related to the IPO set/issue price and/or set/issue number of units of the selected financing instrument 12, which is under direct control of the company underlying the selected financing instrument 12 and is independent of the periodic trade value events of the market 21. For new IPO's, the transition of the company from private (valuation of company under company control) to public (valuation of company under market 21 control) is encountered once the first bid (either at, above, or below the set/issue IPO price) is offered in the market 21 for some portion of the IPO units offered by the issuer.

Another example-of the fundamental value 310 is the conversion date upon which the selected financing instrument 12:changes asset classes (e.g. converts from one asset class to another). One example of this conversion process is the change of a common equity financing instrument 12 to an income trust financing instrument 12. It should be recognised that in the class conversion example, the IPO price of the financing instrument 12 in the converted class is the closing price in the original class the day before the conversion date. It is recognised in this example that the only fundamental value 310 in complete control of the company underlying the financing instrument 12 and therefore external to the periodic trade value events (e.g. closing price) of the markets 21 is the conversion date.

Another example of the fundamental value 310 is the transfer date upon which the selected financing instrument 12 transfers from one market 21 to another market 21. One example of this transfer process is the transfer of the selected financing instrument 12 from a secondary exchange to a primary exchange. It should be recognised that in the market 21 transfer example, the IPO price of the financing instrument 12 in the subsequent market 21 is the closing price in the original market 21 the day before the transfer date. It is recognised in this example that the only fundamental value 310 in complete control of the company underlying the financing instrument 12 and therefore external to the periodic trade value events (e.g. closing price) of the markets 21 is the transfer date.

### Macro Indicator Module 316

Referring again to FIG. 4, the system can have a macro indicator module 316 configured for calculating macro economic and market 21 measures 318 that are related predominantly to external information 50. This kind of macro economic benchmarking can place ratings or investment assessments in meaningful context, thus ensuring useful and appropriate sector-to-sector or business-to-business comparisons. Background information on prices provides context within which specific and momentary prices may have meaningful implications. Trends or changes in their relationship and changes in trends can help identify broad economic opportunity or risk that can dominate any and all particular market 21 values and should be known, to help understand the merit in specific financing instrument 12 evaluations or analysis.

Examples of the indicators 318 are as follows. The module 316 can be configured to determine on a current frequency 304 basis, for example, to obtain and record broad economic data related to price in the context of other prices to calculate benchmark national/multinational economic conditions (e.g. inflation rate in terms of trailing 12-month rate of inflation as measured by changes in money supply or the consumer price index for the region in which the selected financing instruments 12 are relevant). The module 316 can be configured, for example, to determine on a current frequency 304 basis to obtain and record broad economic data related to money supply to calculate benchmark current risk-free rate of return (e.g. current Treasury bill interest rates for the nation of most relevance to the selected financing instruments 12). The module 316 can be configured to determine a risk-adjusted price to earnings ratio by dividing 1 by the Benchmark Current Risk-free Rate of Return.

Further examples of the indicators 318 are: on periodic basis, a few times a year, obtain broad economic data of a similar nature for at least the next relevant range of consideration to calculate a Benchmark Dominant Economic Influencers (e.g. inflation as measured by the trailing annual change in money supply or the trailing average consumer price index for the surrounding or most influential next largest region in which the financing instruments 12 exist); on a periodic basis, a few times a year, obtain and record broad economic data related to money supply to calculate a Benchmark Dominant Risk-free Rate of Return (e.g. Current Treasury Bill interest rates for the surrounding or most influential next largest region in which the financing instruments 12 exist); on a periodic basis, subtract Benchmark of Surrounding Regional Economic Influencers from Benchmark of National Economic Conditions to calculate a Benchmark Difference in Significant Inflation Rates; and on a periodic basis, subtract Benchmark of Current Risk-free Rate of Return from Benchmark Dominant Risk-free Rate of Return to calculate a Benchmark Difference in Significant Rates of Return.

### Relative Value Module 320

The relative value module 320 is configured for calculating relative values 322 for each of the selected financing instruments 12 based on predominantly internal information 52 and potentially some external information 50, as desired. These relative values 322 are indicators of direct relevance to the constituent underlying companies of the selected financing instruments 12 and can be used for internal benchmarking purposes, as described above. For example, the relative values 322 can be values such as but not limited to: Divide current per unit Distribution Rate by Price (e.g. Yield); Divide past distribution rate by past 18 month trailing periods or more (e.g. Past yield); Subtract Past Yield from Yield and divide that result by Past Yield (e.g. Distribution rate/change); Subtract Past Revenues from Current Revenues and divide that result by Past Revenues (e.g. Revenues Growth); Subtract Past Capital Expenditures from Current Capital Expenditures and divide that result by Past Capital Expenditures (e.g. Revenues Growth); Subtract Operating Costs from Revenues and divide by revenues to produce a percentage value (e.g. Pre-Tax Profit Margin); Divide cash Dividend payments by Cash Flow from Continuing Operations (e.g. Operational Cashflow Payout Ratio); Divide Tangible Book Value by Nominal Book Value (e.g. Price to Book Value Ratio); Divide Price by Tangible Book Value (e.g. Price to Tangible Book Value Ratio); Divide Debt by Equity value (e.g. Debt to Equity Ratio); and Divide Returns by Invested Capital (e.g. Returns to Invested Capital Ratio). It is recognised that the Operational Cashflow Payout Ratio is commonly considered only a secondary factor in assessment after traditional Payout Ratio which makes use of dividends paid divided by Net Earnings. This common measure can be manipulated by managers to appear favorable despite more fundamental considerations of the productivity or viability of ongoing operations (better assessed with an operational and cash-oriented measure).

Further, the relative value module 320 can be configured for calculating typical (e.g. median) relative values 324 for the group of the selected financing instruments 12, based on the relative values 322. These relative values 324 are indicators of direct relevance to the constituent underlying companies of the selected financing instruments 12 and can be used for internal benchmarking purposes, as described above. For example, the average relative values 324 can be values such as but not limited to: Calculate median in series of Market Capitalization values for all Company-Issues (e.g. Universe Median Market Size); Calculate median in series of Yield values for all Company-Issues (e.g. Universe Median Yield); Calculate median in series of Pre-tax Profit Margin or all Company-Issues (e.g. Universe Median Pre-Tax Profit Margin); Calculate median in series of Operating Cashflow Payout Ratio or all Company-Issues (e.g. Universe Median Payout Ratio); and For all Companies-issues in the sub-sector for oil and gas producers, calculate the average in series of Reserve Life Index (RLI) (e.g. Sector Average RLI).

It is recognised that median measures of the selected financing instrument 12 group can provide better on-going indication of conditions as long as the group is comprehensive for a particular realm with more than a few, i.e. a significant number, of constituents. Particularly when taken along with a range of maximum and minimum, median values provide useful information. Even without the range of values, a median measure can be fast and sufficient as a general indication for the group. Furthermore, it is recognised that market-weight average calculations (based on external information 50) are ineffective measures in terms of fundamental merit because the results incorporate consideration of pricing that is influenced by buyers as much as sellers over time.

### Consideration Module 326

Referring again to FIG. 4, a consideration module 326 is configured by the system 18 to determine if there are any quantifiable concerns 328 or differentiating advantages 330 for the companies of the selected financing instruments 12. The concern measures 328 are intended to indicate situations that may cause the investor to question whether (i.e. perceive potential risk) the respective financing instrument 12 is worthwhile to own. For example, the concern measures 328 can be such as but not limited to: if current INHERENT RISK FACTORS are greater than 0 then indicate with −1; Risky Payout Ratio such that if Payout Ratio is greater than 100% or less than 0, then indicate with a −1; Negative Returns such that if Price to Tangible Book ratio or Return on Invested Capital ratio less than 0 or if Debt to Equity greater than 1.1 then indicate with a −1; Less Tangible than Intangible Value such that if Tangible Book Value less than Intangible Book Value then indicate with a −1; and Not Informative or Focused such that if Convertible Debenture has been issued by same company or if the company has no Web site then indicate with a −1. It is recognised that the concern measures 328 with a value of zero indicate that no situations have been found that would cause the investor to question investment in the respective financing instrument 12, as compared to a value of negative one which would indicate that a situation has been found that should cause the investor to question potential risk of loss with an investment in the respective financing instrument 12, for example. It is recognised that because inherent complexity or lack of communications by a company creates informative risks to the investor and company owners, evidence of such risk (e.g. deemed Not informative or Focused) can be useful as indication of other potential risks.

The advantage measures 330 are intended to indicate situations that may cause the investor to favour investment in the respective financing instrument 12. For example, the advantage measures 330 can be such as but not limited to: pre-tax Profit Margin greater than Unversed Median Pre-tax Profit Margin then indicate with a positive 1; Low Payout Ratio: if Operating Cashflow Payout Ratio less than 60% then indicate with a positive 1; balanced Debt to Equity: If Equity minus Debt is greater than 0 then indicate with a positive 1; Reserve Life Index Greater than Average: If Company is an Oil and Gas producer and if RLI greater than Sector average RLI then indicate with a positive 1; and Demonstrative Growth if 3-year Revenue Growth plus 3-year Capital Spending Growth plus 3-Year Distribution Growth is greater than 0 and if 3-Year Revenue Growth is greater than 3-Year Capital Spending Growth then indicate with a positive 1. It is recognised that the advantage measures 330 with a value of zero indicate that no situations have been found that would cause the investor to favour investment in the respective financing instrument 12, as compared to a value of positive one which would indicate that a situation has been found that should cause the investor to favour potential investment in the respective financing instrument 12, for example.

### Benchmarking Module 332

A price related benchmarking module 332 is used to calculate price benchmarks 334 that can be a combination of internal 52 and external 50 information. For example, the benchmarking module 332 can be configured to calculate for each company with a security in the Index (e.g. selected financing instruments 12) the Current Frequency 304, for the following values: compare current value of price time units in the Index value to the original price times units in the Index purchase and first calculate annualized price gains before adding to it the annual percentage rate of distributions to determine Total Annualized Returns by selected financing instrument 12 (e.g. Total Annualized Returns); Consider each sector 30 and overall security class, calculate the median value of Total Return for the class (e.g. market based return benchmark); duplicate all Company-Issue information by sector 30 of economic involvement (e.g. sectors benchmark); consider each sector 30 and overall security class, calculate the median value of Total Return for sectors 30 within the class (e.g. market based sector return benchmark); compare Current and Prior Market-based Sector Return Benchmarks and Market-based Return Benchmark such that if Current is greater than prior values then there is generally a flow of money into the Sector or Universe; and determine negative INHERENT RISK and INHERENT QUALITY OF RETURNS in terms of current fundamental measures, add nominal positive factors of an equal potential number relative to, and from which are subtracted, negative fundamental quality factors (e.g. fundamental quality score).

It is recognised that the sectors benchmark can represent for example, oil and Gas Producers including oil or gas specialists and operators with mixed output, energy-related including upstream services, processors and distributors, food-related including beverages, as well as production, distribution and retailing enterprises, real Estate Investment (property owners and facility operators including lodging services), and other Business including resource-based, industrial or commercial and consumer-oriented operations. Further, it is recognised that sector specification and monitoring of median and maximum/minimum numbers of the selected financing instruments 12 can enable the investor to see trends in operating environments or circumstances. In general, sector specification provides a starting point for detailed strategic considerations for each company if or when Ratings results raise questions for further research. As important, changes can pre-sage direction in pending shifts in price-related company valuations without use of sophisticated or time consuming projections of “Target” or “Fair” prices for securities from the company.

### Factor Module 336

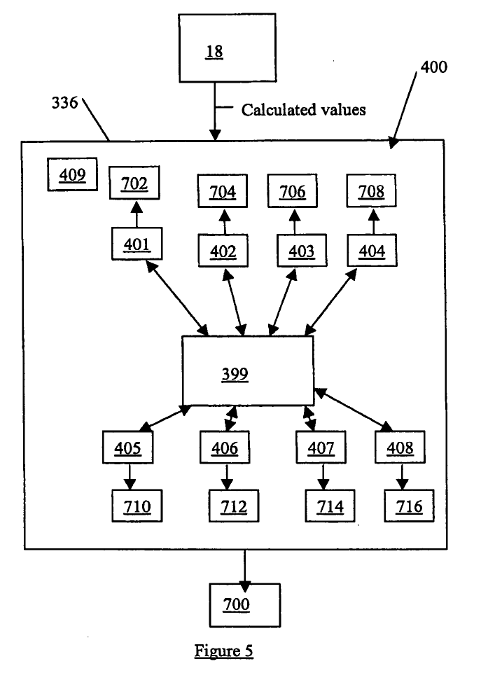

A factor module 336 is configured to calculate the evaluation factors 700 (see FIG. 6) used to facilitate the trade decisions for the selected financing instruments 12. It is recognised that these evaluation factors 700 represent a combination of internal and external benchmarking measures as described above. Further details including operation of the factor module 336 are described below in connection with FIGS. 5,6 and 8.

It is recognised that assignment of the any particular factor 700 can mean the inclusion or exclusion of the factor 700, as desired.

### Report Module 338

A report module 338 is configured for assembling the calculated measures 310,314, 315, 318,322,324,328,330,334 and factors 700 for inclusion, where appropriate, in the evaluation report 19. The module 338 can perform sorting of the selected financing instruments 12 in the evaluation report 19 based on a predefined ranking system based on the at least some of the calculated measures and/or the factors 700, as desired.

The sorting of the financing instruments 12 in the evaluation report 12 include a historical perspective in the factors 700, for example such as but not limited to: past assignments of the factors 700 for specified dates/times (e.g. the last two or more consecutive report 19 cycles) indicate the repeated assignment (and/or lack of assignment) of a particular factor 700 or group of factors 700 (e.g. factor 716); as well as the maximum number of factors 700 or specific factors 700 assigned over time. The report module can also highlight certain factor patterns, such as but not limited to: the assignment for at least one factor 702-714 with the factor 716; the assignment of the factor 716; combination of the factor 702 and the factor 716; etc.

In terms of sorting, the report module 338 can perform any of the following: grouping financing instruments 12 by sector 30; grouping financing instruments 12 in a list according to the number of factors 700 (e.g. seven, followed by six, etc.) assigned; worst/best potential (e.g. two factors 702-714 or less with factor 716, five factors 702-714 with no factor 716); with or without factor 716; and sort on any particular factor 700 or group of factors 700. Further, it is recognised that the report 19 can contain a list of the selected financing instruments 12 including their number of factors 700 and their Total Annualized Return value.

It is recognised that the modules 299 of the financing instrument evaluation system 18 can be configured to operate independently of an evaluation administrator (not shown) once configured and/or to interact with the evaluation administrator though a user interface 202 (see FIG. 9) of the computing device 101 hosting the respective module(s) 299, in order to carry out the intended functionality and related operations of the respective module(s) 299. Further, it is recognised that the modules 299 can be configured to operate interactively as shown, the operations/functionality of the selected modules 299 can be combined or the operations/functionality of the selected modules 299 can be further subdivided, as desired. Further, it is recognised that the modules 299 can communicate or otherwise obtain their calculated results (e.g. quantities 304, 310, 314, 318, 700, etc.) from one another or can store their respective calculated results in the storage 210 for subsequent retrieval by another module 299 there-from.

### Evaluation Factors 700

Referring to FIG. 6, shown is an example portion of an evaluation report 19 including the calculated factors 700 for selected financing instruments 12. The calculated factors 700 can include factors such as but not limited to 8 evaluation ratings/factors. The factors 700 are calculated according to a repeatable and systematic ratings methodology based at least in part on equivalent time-based benchmarking quantities, which use the INDEX WEIGHT value 315 in order to provide for comparison of the selected financing instruments 12 on an equivalent per unit basis. Further, use of the fundamental value 310 provides for the construction of the equivalent-weight and time-scale index which facilitates the integrity of perspective being protected and remaining in tact by measuring change in price over time relative to the fundamental value 310 of the company (e.g. related to the original value of the issue—IPO price). Accordingly, use of the particular time scale facilitates information derived from it to remain essential or fundamental in relation to the company-issue being considered (e.g. an equivalent basis for each company from which to compare changes in distribution rates). It is recognised that any of the following predefined thresholds could be stored in storage 210 for reference by the appropriate module 400 of the factor module 336 (see FIG. 5).

The first evaluation factor 702 represents an indication whether the selected financing instrument 12 has a history of being more than a predefined period of time (e.g. one year). Meeting or exceeding the predefined period of time would result in the assignment of the first evaluation factor 702 to the selected financing instrument 12. For example, a stock being listed/traded on an exchange (e.g. market 21) for more than one year provides a mechanism (e.g. regular series of pricing events) to compare current financing instrument 12 price (i.e. Nominal Current Value of the financing instrument 12) against. The factor 702 could also be a positive indicator of the availability of financial reports from the respective company, which could be useful as a source of information 50,52 for benchmarking calculations. It should be recognised that the first factor 702 represents a solely internal benchmark, i.e. a benchmark that uses fundamental measures specific to the business and is not reliant solely on external current market 21 conditions (e.g. buyer/seller set financing instrument 12 price and/or volumes).

The second evaluation factor 704 represents an indication of the relative liquidity of the selected financing instrument 12 being more than a predetermined market capitalization threshold. For example, multiplying the current price of the financing instrument 12 by the current number of units listed (i.e. Nominal Current Value of the financing instrument 12) by the market 21 and comparing against the market capitalization threshold (e.g. median capitalization for securities of that class in that market) would result in the assignment of the second evaluation factor 704 to the selected financing instrument 12. It should be recognised that the second factor 702 represents a combination of internal and external benchmarks, i.e. benchmark that include both internal company fundamentals (through the use of the Nominal Current Value of the financing instrument 12 in the factor 704 calculations) and external current market 21 conditions (e.g. buyer/seller set financing instrument 12 price and/or volumes).

The third evaluation factor 706 represents an indication of the net earnings of the company represented by the selected financing instrument 12. For example, the current financing instrument 12 price (i.e. Nominal Current Value of the financing instrument 12) is used to calculate a price/earnings ratio (P/E) which is compared to a predefined earnings threshold, e.g. P/E greater than zero but less than maximum (e.g. double the median P/E for trusts), which if met would result in the assignment of the third evaluation factor 706 to the selected financing instrument 12. It should be recognised that the third evaluation factor 706 represents a combination of internal and external benchmarks, i.e. benchmark that include both internal company fundamentals (through the use of the Nominal Current Value of the financing instrument 12 and company earnings in the factor 706 calculations) and external current market 21 conditions (e.g. combined with buyer/seller set financing instrument 12 price).

The fourth evaluation factor 708 represents an indication of positive demand of the selected financing instrument 12, as compared to a predefined demand threshold. For example, based on analysis of internal information 52, if the company operates in a sector 30 where demand exceeds supply (demand threshold) or sponsorship of the financing instrument 12 by financiers exceeds the demand threshold, then the fourth evaluation factor 708 would be assigned to the selected financing instrument 12. It should be recognised that the fourth evaluation factor 708 represents an internal benchmark, i.e. a benchmark that uses business fundamentals and is not reliant solely upon external current market 21 conditions (e.g. buyer/seller set financing instrument 12 price and/or volumes).

The fifth evaluation factor 710 represents an indication of a fundamental leader of the company underlying the selected financing instrument 12. For example, a review of the quantifiable concerns 328 or differentiating advantages 330 indicators calculated by the consideration module 326 could be used to determine if the selected financing instrument meets any predefined positive/negative perceived business fundamentals, such that negative connotations would inhibit assignment of the fifth evaluation factor 710 to the selected financing instrument 12 while positive connotations would result in assignment of the fifth evaluation factor 710 to the selected financing instrument 12. It should be recognised that the fifth evaluation factor 710 represents a predominantly internal benchmark, i.e. a benchmark that uses business fundamentals and is not reliant solely upon external current market 21 conditions (e.g. buyer/seller set financing instrument 12 price and/or volumes).

The sixth evaluation factor 712 represents an indication of the rate of change in distribution or dividend, i.e. change/growth of cash flow from the company of the selected financing instrument 12. The calculated distribution change/growth (part of the relative values 322 calculated for each selected financing instruments 12 by the relative value module 320) is compared to a predetermined growth threshold (e.g. average rate of inflation). Meeting or exceeding the predetermined growth threshold would result in assignment of the sixth evaluation factor 712 to the selected financing instrument 12. It should be recognised that the fifth evaluation factor 710 represents a predominantly internal benchmark, i.e. a benchmark that uses business fundamentals and is not reliant solely upon external current market 21 conditions (e.g. buyer/seller set financing instrument 12 price and/or volumes).

The seventh evaluation factor 714 represents an indication of total returns of the selected financing instrument 12 exceeding a predefined total returns threshold (e.g. median return), which would result in the assignment of the seventh evaluation factor 714 to the selected financing instrument 12. It is recognised that the benchmarking module 332 is used to calculate the price benchmarks 334 of the selected financing instrument 12, including the annualized total return. Further, it should be recognised that the Nominal Current Value of the financing instrument 12 (including the fundamental value 3 10) is used in substitution of the current market 21 price of the financing instrument 12 in the calculation of the total return. Accordingly, it should be recognised that the seventh evaluation factor 714 represents a predominantly internal benchmark, i.e. a benchmark that uses business fundamentals and is not reliant solely upon external current market 21 conditions (e.g. buyer/seller set financing instrument 12 price and/or volumes), however does include the current financing instrument 12 price (obtained from the market 21) in calculation of the total return.

The eighth evaluation factor 716 represents an indication of cash flow problems of the company for the selected financing instrument 12 exceed a predefined cash flow threshold. An example of this threshold is payout from operating cash flow is greater than 100% and/or the growth/change in the distribution rate is less than zero, which would result in the assignment of the eighth evaluation factor 716 to the selected financing instrument 12. it should be recognised that the eighth evaluation factor 716 represents a predominantly internal benchmark, i.e. a benchmark that uses business fundamentals and is not reliant solely upon external current market 21 conditions (e.g. buyer/seller set financing instrument 12 price and/or volumes)

In view of the above as defined, it is recognised that assignment of any of the first seven factors 700 to the selected financing instrument 12 can be regarded as positive indicators of well being for the company, while assignment of the eight factor 716 to the selected financing instrument 12 can be regarded as a negative indicator of well being for the company. However, it is recognised that changing the definition of the thresholds could result in any of the first seven factors 700 being regarded as negative indicators and the eight factor 716 as positive (e.g. the predefined cash flow threshold is a payout from operating cash flow is less than 100% and/or the growth/change in the distribution rate is greater than zero), as desired.

### Factor Module 336

Referring to FIG. 5, the factor module 336 is configured to use the calculations performed by the other modules 299 of the system 18 in order to determine the assignment (or lack of assignment) of any of the factors 700. It is recognised that the factor module 336 could be configured to perform some or all of these calculations of the module 299 during the process of assigning the factors 299, as well as to consider additional information 50,52, as desired. It is recognised that the workflow engine 306 (see FIG. 4) could be used to coordinate cyclic use of the factor module 336 with the calculated results of the other modules 299, as the calculated values (e.g. measures 310,314, 315, 318,322,324,328,330,334) become available. For example, assignment of the fifth evaluation factor 710 would be determined once the quantifiable concerns 328 or differentiating advantages 330 indicators were made available by the consideration module 326, prior to calculation of the other measures 310, 314, 318, 322, 324, 334 used in determining the assignment of the other factors 700.

The factor module 336 has further modules 400 configured to make the assignment decisions of the factors 700 based on the calculated values, either once all the calculations (e.g. measures 310,314,318,322,324,328,330,334) have been performed or in a cyclic fashion as described. Accordingly, each of the modules 400 has access to the predefined thresholds described above, referenced generically by the reference numeral 399 by example. A first module 401 makes the decision on whether to assign the first evaluation factor 702. For example, for each Issue, subtract IPO Date from Current Date (e.g. Current Period of Indexation), if Current Period of Indexation equal to or greater than 1, then provide as positive indication (e.g. Market Proven Security). A second module 402 makes the decision on whether to assign the second evaluation factor 704. For example, for each Issue, if Market Capitalization is greater than Universe Median Market Size then a Star is provided as positive indication (e.g. Relative Potential Liquidity).

A third module 403 makes the decision on whether to assign the third evaluation factor 706. For example, if Earnings greater than 0 then subtract Issue Price to Earnings Ratio from Risk Adjusted Price to Earnings Ratio (Price to Risk Adjusted Earnings Differential), if Price to Risk Adjusted Earnings Differential greater than 0 then provide a Star as positive indication (e.g. Positive Earnings on a Risk Adjusted Basis). A fourth module 404 makes the decision on whether to assign the fourth evaluation factor 708. For example, subtract Gross Revenues from three years prior from recent Gross Revenues (3-year Revenue Difference), if 3-year Revenue Growth is greater than 0 then provide a positive indication (Fundamental Business Demand), for each Issue if Yield is equal to or less than Universe Median Yield than provide a positive indication (Market-based Security Demand), if either Fundamental Business Demand or Market-based Security Demand is greater than 0 then a Star is provided as positive indication (e.g. Positive Buyer Demand).

A fifth module 405 makes the decision on whether to assign the fifth evaluation factor 710. For example, if the Fundamental Quality Score is greater than zero then provide a Star as positive indication. A sixth module 406 makes the decision on whether to assign the sixth evaluation factor 712. For example, observing cash distribution frequency and rates each security, calculate the annual percentage rate of increase for the trailing 12 months and for the prior year (distribution growth rate (%)), observing the trailing 12-month average Rate of Inflation as measured by the Total Consumer Price Index, compare the rate of Distribution Growth to the rate of inflation (difference of security to economic benchmark), if the Distribution Growth rate is greater than the Rate of Inflation for the security then provide a Star as a positive indication. A seventh module 407 makes the decision on whether to assign the seventh evaluation factor 714. For example, for each issue subtract Total Return from Median Return and if greater than zero then provide a Star as a positive indication. An eighth module 408 makes the decision on whether to assign the eighth evaluation factor 716. For example, for each Issue, if Payout from Operating Cashflow is greater than 100% or if Change in Distribution Rate is less than zero then provide a Cashflow Caution as negative indication.

In view of the above, it is recognised that the above described ratings process provides for allocation of factors/stars 700 as septic individual and collective indicators. Further, the factors 700 combine both positive and negative indicators as measurements for both financing instrument 12 investment quality and company reporting practices. Further, for the fifth factor 710, this is representative of the buyers' evaluative ability and potential for return from a particular purchase. The functioning of efficient markets rely in no small way on recollection and memory of evidence, in the moment, that there is risk. Value depends on good information and that it is available as part of public record much as this measure provides positive indication when there is relatively little indication of risk including record of previously recorded occurrences of bad behavior.

It is recognised that the factor module 336 could also have a decision module 409, which would be configured to halt the assignment process for the factors 700 based on one or more predefined decision thresholds. For example, failure to be assigned any one or combination of factors 700 would result in termination of the remaining assignments/calculations by the system 18 for the selected financing instrument 12. For example, failure to assign any of the factors 700 (e.g. the first factor 702) would result in termination of any or all of the remaining assignments/calculations by the system 18 for the selected financing instrument 12. For example, failure to assign any two of the factors 700 (e.g. the factors 702, 704) would result in termination of any or all of the remaining assignments/calculations by the system 18 for the selected financing instrument 12. For example, failure to assign any three of the factors 700 (e.g. the factors 702, 704, 706) would result in termination of any or all of the remaining assignments/calculations bad the system 18 for the selected financing instrument 12. For example, failure to assign any four of the factors 700 (e.g. the factors 702, 704, 706, 708) would result in termination of any or all of the remaining assignments/calculations by the system 18 for the selected financing instrument 12. For example, failure to assign any five of the factors 700 (e.g. the factors 702, 704, 706,708) would result in termination of any or all of the remaining assignments/calculations by the system 18 for the selected financing instrument 12. For example, failure to assign any six of the factors 700 would result in termination of any or all of the remaining assignments/calculations by the system 18 for the selected financing instrument 12. For example, failure to assign any seven of the factors 700 would result in termination of any or all of the remaining assignments/calculations by the system 18 for the selected financing instrument 12. It is recognised that the decision module 409 could be part of the workflow module 306, as desired. Further, it is recognised that the factor module 336 and modules 399 could be configured other than as described, as desired.

Operation of the Financing instrument Evaluation System 18

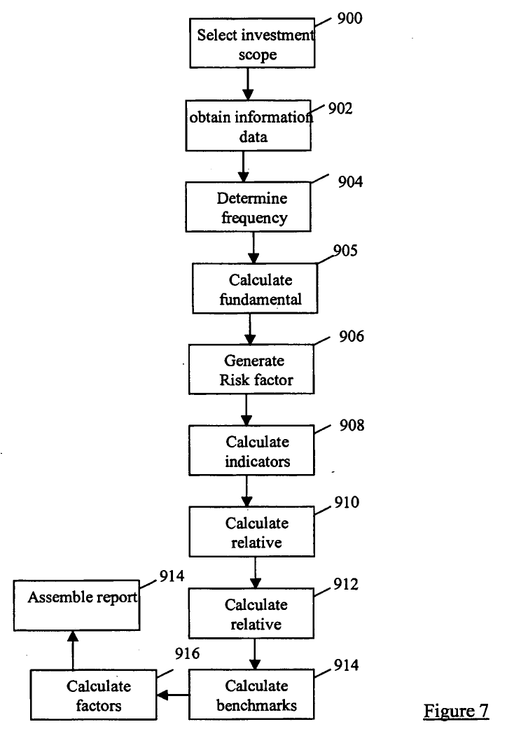

Referring to FIGS. 4 and 7, shown is an example overlying operation of the financing instrument selection system 18. At step 900, the scope of investment is determined through the scope module 301 for the desired mix of chosen financing instruments 12 and/or sectors 30 (see FIG. 2). The entity 16 (and/or portfolio management system 22) desiring the evaluation report 19 (e.g. either initially or on a repeated basis) provides the investment scope information 23 to the scope module 21, which is configured to then identify the available information sources 302 for obtaining the required investment information 50,52. In the event that information 50,52 is currently unavailable (e.g. no known source 302) for financing instruments 12 embodied by scope information 23, then the scope module 21 may communicate this to the entity 16 and/or portfolio management system 22 which may result in a change to the investment scope information 23. It is recognised that for recalculations of the evaluation report 19, the investment scope information 23 can be supplied by the workflow engine 306 from the storage 210 based on the respective defined evaluation frequencies 304.

At step 902, the data collection module 300 is used to collect the desired information 50,52 for selected financing instruments 12, selected sectors 30 (see FIG. 2), etc. as determined in step 900. It is recognised that step 902 can be performed oen a periodic basis as directed by the workflow engine 306 according to the defined evaluation frequencies 304 determined by the frequency module 301. Further, it is recognised that the obtained information 50,52 could be new or could otherwise amend/supplement data already available in the storage 210. For example, the module 300 can obtain the recent closing price of the financing instruments 12 on the market(s) 21 for repeated report 19 generation, based on the frequency 304 calculated in step 904.

At step 904, the frequency module 308 calculates the frequency 304 for those financing instruments 12 having a minimum calendar reporting history, for example. This frequency is stored in the storage 210 and is used by the workflow engine 306 to trigger subsequent repeated generation(s) of the evaluation report 19. At step 905, the Nominal Current Value of the financing instrument 12 is calculated (based on the fundamental value 310) by the module 315, which is used in substitution of the current market 21 price of the financing instrument 12 in the subsequent calculation of the measures 314,318,322,324,328,330,334 and the factors 700. At step 906, optionally the risk module 312 can calculate the risk factor 314 based on relevant internal information 52 collected by the collection module 300, for example. At step 908, the macro module 316 calculates the macro indicators 318 using external information 50.

At step 910, the relative value module 320 calculates relative values 322, 324 for each of the selected financing instruments 12 based on predominantly internal information 52 and potentially some external information 50, as desired. These relative values 322, 324 are indicators of direct relevance to the constituent underlying companies of the selected financing instruments 12 and can be used for internal benchmarking purposes, as described above. At step 912, the consideration module 326 determines if there are any quantifiable concerns 328 or differentiating advantages 330 for the companies of the selected financing instruments 12. At step 914 the benchmarking module 332 calculates price benchmarks 334. At step 916, the factor module 336 calculates the evaluation factors 700 used to facilitate the trade decisions for the selected financing instruments 12. At step 918, the report module 338 assembles the calculated measures 310, 314, 318, 322, 324, 328, 330, 334 and factors 700 for inclusion, where appropriate, in the evaluation report 19, as well as performs sorting of the selected financing instruments 12 in the evaluation report 19 based on the predefined ranking system. the report 19 is then sent to the entity 16 and/or system 22.

### Operation of the Factor Module 336

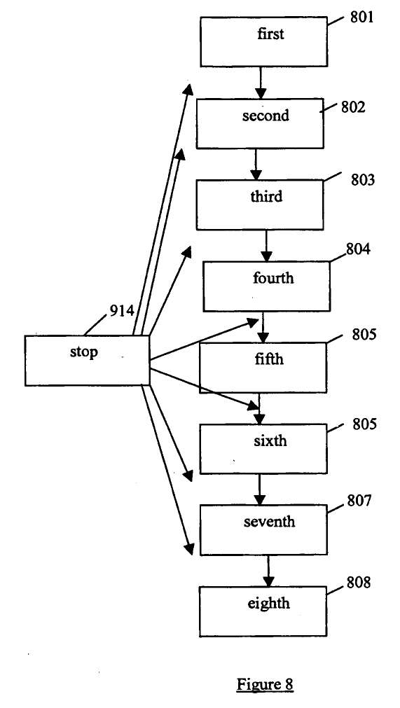

Referring to FIG. 8, at step 801 the first factor 702 is calculated, at step 802 the second factor 704 is calculated, at step 803 the third factor 706 is calculated, at step 804 the fourth factor 708 is calculated, at step 805 the fifth factor 710 is calculated, at step 806 the sixth factor 712 is calculated, at step 807 the seventh factor 714 is calculated, and at step 808 the eighth factor 716 is calculated (and any further factors 700 other than described, as desired). It is recognised that positioned intermediate to any of the steps could be step 809 for deciding whether to continue the calculation/assignment of the factors 700. Further, it is recognised that the order of factor 700 assignments could be other than described. Further, it is recognised that other factors 700 than described could be used to represent internal and/or external benchmarking.

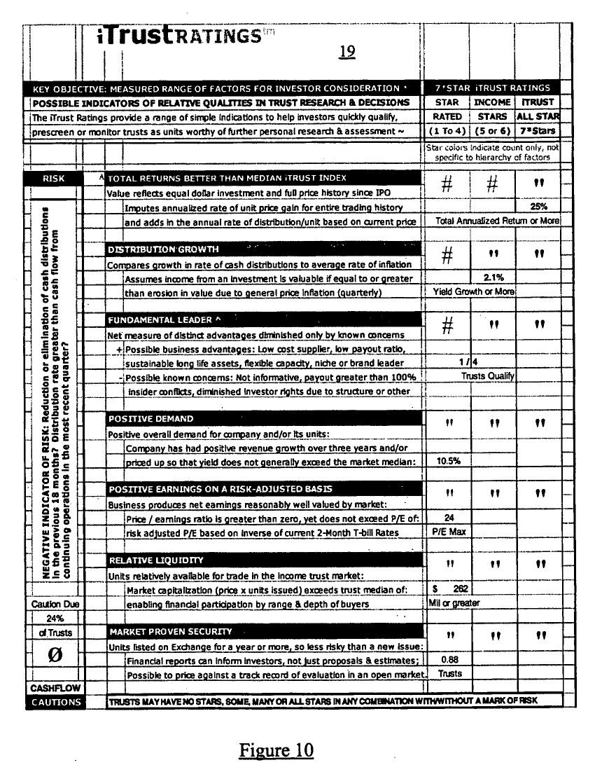

Referring to FIG. 10, shown is an example assignment of factors 700. For example, for the sector 30 of Canadian income trusts for all markets 21 as of Dec. 6, 2006, 88% of trusts (e.g. selected financing instruments 12) would have received the first factor 702, trusts with relative liquidity greater than $262 million or greater would have received the second factor 704, trusts with a P/E max less than 24 would have received the third factor 706, less that 10.5% of trusts would have received the fourth factor 708, only 25% of trusts would have received the fifth factor 710, those trusts with growth greater than 2.1% would have received the sixth factor 712, only 25% of trusts would have received the seventh factor 716, and 24% of trusts would have received the eighth factor 716 indicating a negative indicator (e.g. cashflow caution). It is recognised that the order of the factors 700 may be in increasing difficulty to get, i.e. it is easier to get the first factor 702 than the second factor 704 and so on, basically.

### Computing Devices 101

Referring to FIGS. 1 and 9, each of the above-described components of the investment management environment 10, i.e. investing entities 16, financing instrument evaluation system 18, markets 21, portfolio management system 22, execution system 24, risk control system 26 can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 11 (e.g. an intranet and/or an extranet such as the Internet), which enables the devices 101 to communicate with each other as appropriate. The network 11 can support the communication of the evaluation report 19 and the corresponding search/request/transfer of information 50,52 between the components of the environment 10.

Referring again to FIG. 9, the devices 101 can also have a user interface 202, coupled to the device infrastructure 204 by connection 222, to interact with a user (e.g. entity 16, system 18 administrator, system 22 administrator, etc.). The user interface 202 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the entities 16 can be configured to interact with a web browser (e.g. applications 207) to formulate the search requests 105 as well as process the received search results 106 (e.g. access via the links 103 the matched entities 400 available on websites (e.g. applications 207) of the hosting devices 101. For the devices 101 -used by the system 18, the user interfaces 202 can be used by a system 18 administrator to coordinate operation (e.g. manually or automated through association software—e.g. applications 207) of the various modules 299,399 to result in generation of the evaluation report 19 for sending to the respective entity 16 and/or system 22, as farther described below.

Referring again to FIG. 9, operation of the devices 101 is facilitated by the device infrastructure 204. The device infrastructure 204 includes one or more computer processors 208 and can include an associated memory 210 (e.g. a random access memory). The computer processor 208 facilitates performance of the device 101 configured for the intended task through operation of the network interface 200, the user interface 202 and other application programs/hardware 207 of the device 101 by executing task related instructions. These task related instructions can be provided by an operating system, and/or software applications 207 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client applications 207. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination.

Further, it is recognized that the computing devices 101 can include the executable applications 207 comprising code or machine readable instructions for implementing predetermined functions/operations including those of an operating system, a web browser, the system 18 modules 299,399 for example. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of the system 18 (e.g. modules 299,399) may be implemented in hardware, software or a combination of both. Accordingly, the use of a processor 208 as a device and/or as a set of machine-readable instructions is hereafter referred to generically as a processor/module for sake of simplicity. Further, it is recognised that the system 18 can include one or more of the computing devices 101 (comprising hardware and/or software) for implementing the modules 299,399, as desired.

It will be understood that the computing devices 101 of the entities 16 may be, for example, personal computers, personal digital assistants, mobile phones, and content players. Server computing devices 101 can be configured for the financing instrument evaluation system 18, markets 21, portfolio management system 22, execution system 24, and risk control system 26 as desired. Further, it is recognised that each server computing device I 01, although depicted as a single computer system, may be implemented as a network of computer processors, as desired.

### Appendix

The following appendix includes an example operation of the evaluation system 18 resulting in the appended example report 19. Identified in the example report 19 are the column categories of: companies (e.g. selected assets 12); their inclusion in a particular market sector 30; contact information of the underlying companies of the selected assets 12; calculated measures including cash distribution rates changes and trends, payout ratio recent QTR, reported growth rates, current market 21 price, issue size, financial ratios, original index values; itrust value index including asset 12 values calculated using the fundamental value 310, and current concern 328 and advantage 330 measures; financial report data for calculations including cash-flow data including dividend information; and itrust star/factor 700 assignments, where a “1” indicates the assignment of a respective factor 700 has occurred and a “−” indicates the non-assignment of a respective factor 700, and the last column indicating a total for the number of factors 700 assigned. It is noted that for this example report 19 that the assets 12 have been sorted into a list row by row based on alphabetical order of their exchange symbols.

I claim:

1. A system for evaluating financing instruments selected from a group of financing instruments available on a market, the market for providing a plurality of dynamic exchange-based valuation events for each of the selected financing instruments, the system comprising:
an equivalence module configured for determining a fundamental value for each of the selected financing instruments, the fundamental value including at least one quantity independent of the dynamic exchange-based valuation events;
a measures module configured for calculating a plurality of measures based on information related to each of the selected assets;
a factor module configured for assigning at least one evaluation factor to each of the selected financing instruments when a threshold criterion is satisfied according to the comparison of at least one of the plurality of measures with at least one valuation including the fundamental value; and
a report module for assembling the result of the evaluation factor assignment in a report for sending to a requestor of the report.

2. The system according to claim 1, wherein the fundamental value is related to an IPO set price for the respective selected financing instrument for new issues.

3. The system according to claim 1, wherein the fundamental value is related to a transfer date for transferring at least some of the selected financing instruments from the market to a second market.

4. The system according to claim 1, wherein the fundamental value is related to a conversion date for converting at least some of the selected financing instruments from one asset class to a different asset class.

5. The system according to claim 2, wherein the dynamic exchange-based valuation events are selected from the group comprising: market trade price and market trade volume for each of the selected financing instruments.

6. The system according to claim 5, wherein the period of the exchange-based valuation events are selected from the group comprising: real-time; daily; weekly; monthly; quarterly; annually.

7. The system according to claim 2 further comprising the measures module configured for including at least one of the dynamic exchange-based valuation events in the calculation of the plurality of measures.

8. The system according to claim 7 further comprising basing the at least one valuation on a per unit basis.

9. The system according to claim 8 further comprising the factor module configured for assigning the at least one evaluation factor to include an indication of total returns of at least one the selected financing instruments exceeding a predefined total returns threshold.

10. The system according to claim 9 further comprising the factor module configured for assigning the at least one evaluation factor to include an indication of cash-flow of the underlying company for the selected financing instrument exceeding a predefined maximum cash-flow threshold.

11. A method for evaluating financing instruments selected from a group of financing instruments available on a market, the market for providing a plurality of dynamic exchange-based valuation events for each of the selected financing instruments, the method comprising the acts of:
determining a fundamental value for each of the selected financing instruments, the fundamental value including at least one quantity independent of the dynamic exchange-based valuation events;
calculating a plurality of measures based on information related to each of the selected financing instruments;
assigning at least one evaluation factor to each of the selected financing instruments when a threshold criterion is satisfied according to the comparison of at least one of the plurality of measures with at least one valuation including the fundamental value; and
assembling the result of the evaluation factor assignment in a report for sending to a requestor of the report.

12. The method according to claim 11 further comprising the act of relating the fundamental value to an IPO set price for the respective selected asset for new issues.

13. The method according to claim 11 further comprising the act of relating the fundamental value to a transfer date for transferring at least some of the selected financing instruments from the market to a second market.

14. The method according to claim 11 further comprising the act of relating the fundamental value to a conversion date for converting at least some of the selected financing instruments from one asset class to a different asset class.

15. The method according to claim 12, wherein the dynamic exchange-based valuation events are selected from the group comprising: market trade price and market trade volume for each of the selected financing instruments.

16. The method according to claim 15, wherein the period of the dynamic exchange-based valuation events are selected from the group comprising: real-time; daily; weekly; monthly; quarterly; annually.

17. The method according to claim 12 further comprising the measures module configured for including at least one of the dynamic exchange-based valuation events in the calculation of the plurality of measures.

18. The method according to claim 17 further comprising the act of basing the at least one valuation on a per unit basis.

19. The method according to claim 18 further comprising the act of assigning the at least one evaluation factor to include an indication of total returns of at least one the selected financing instruments exceeding a predefined total returns threshold.

20. The method according to claim 19 further comprising the act of assigning the at least one evaluation factor to include an indication of cash-flow of the underlying company for the selected financing instrument exceeding a predefined maximum cash-flow threshold.
